(19) United States
(12) Patent Application Publication
(10) Pub. No.: US 2026/0235897 A1
(43) Pub. Date: Aug. 13, 2026

(54) PHOTONIC DEVICES AND METHODS OF FORMING THE SAME

(71) Applicant: Taiwan Semiconductor Manufacturing Co., Ltd., Hsinchu (TW)

(72) Inventors: Chen-Hua Yu, Hsinchu (TW); Chia-Chia Lin, Kaohsiung City (TW); Chung-Hao Tsai, Huatan Township (TW); Chih-Wei Tseng, Hsinchu (TW); Chih-Chieh Chang, Zhubei (TW); Hsing-Kuo Hsia, Jhubei (TW)

(21) Appl. No.: 19/275,491

(22) Filed: Jul. 21, 2025

Related U.S. Application Data
(60) Provisional application No. 63/758,172, filed on Feb. 13, 2025.
(60) Provisional application No. 63/779,665, filed on Mar. 28, 2025.

(51) Int. Cl. G02F 1/035

(52) U.S. Cl. CPC G02F 1/035

(57) ABSTRACT

A method includes forming a waveguide including a base layer and a protrusion, forming first metal film and a second metal film on opposing sides of the protrusion, and depositing an insulating layer over the first metal film and the second metal film. The insulating layer is etched to form a first opening and a second opening on opposing sides of the protrusion. The first metal film and the second metal film are also exposed to the first opening and the second opening, respectively. A first electrode and a second electrode are formed in the first opening the second opening, respectively. The first metal film includes a first portion between the first electrode and the protrusion. The second metal film includes a second portion between the second electrode and the protrusion. The first electrode and the second electrode are configured to apply an electrical field to the protrusion.

### PRIORITY CLAIM AND CROSS-REFERENCE

This application claims the benefit of the following provisionally filed U.S. Patent application: Application No. 63/758,172, filed on Feb. 13, 2025, and entitled “Compact Photonic Device for Integrated Optics,” and Application No. 63/779,665, filed on Mar. 28, 2025, and entitled “Compact Photonic Device for Integrated Optics,” which applications are hereby incorporated herein by reference.

### BACKGROUND

Electrical signaling and processing are one of techniques for signal transmission and processing. Optical signaling and processing have been used in increasingly more applications in recent years, particularly due to the use of optical fiber-related applications for signal transmission.

In order to achieve optical signaling, electrical signals need to be converted to optical signals, and optical signals need to be converted to electrical signals. Electro-optic modulators are thus developed, and the improvement of the efficiency of the electro-optic modulators is being studied.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A and 1B through FIGS. 6A, 6B, and 6C illustrate the views of intermediate stages in the formation of an electro-optic modulator in accordance with some embodiments.

FIGS. 7 through 10A, 10B, 10C, 11A, 11B, 11C, 12A, 12B, 12C, 12D and 13 through 16 illustrate the views of electro-optic modulators in accordance with alternative embodiments.

FIG. 17 illustrates a process flow for forming an electro-optic modulator in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “underlying,” “below,” “lower,” “overlying,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Electro-optic modulators and the methods of forming the same are provided. In accordance with some embodiments of the present disclosure, an electro-optic modulator includes a waveguide that comprises a protrusion. The waveguide may comprise lithium niobite. Signal and ground electrodes are formed on opposing sides of the protrusion in order to apply voltages, so that an electrical field is applied to the protrusion. The electrical field may change the refraction index of the protrusion, and thus the optical signals in the waveguide are modulated. Metal films are formed to extend from the signal and ground electrodes toward the protrusions. Since metal films are closer to the protrusions than the signal and ground electrodes, without requiring the increase in the voltages, the electrical field applied to the protrusions may be increased, and the efficiency of modulation is improved.

Embodiments discussed herein are to provide examples to enable making or using the subject matter of this disclosure, and a person having ordinary skill in the art will readily understand modifications that can be made while remaining within contemplated scopes of different embodiments. Throughout the various views and illustrative embodiments, like reference numbers are used to designate like elements. Although method embodiments may be discussed as being performed in a particular order, other method embodiments may be performed in any logical order.

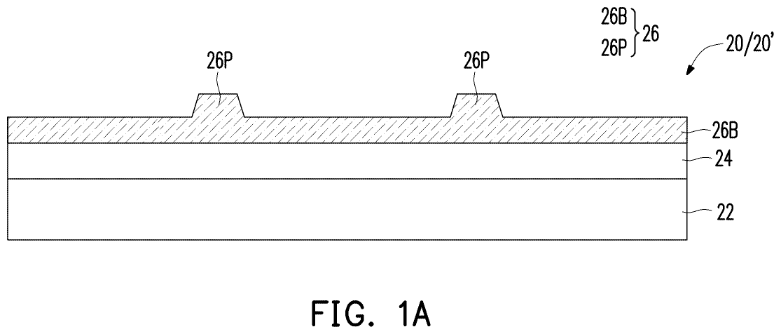

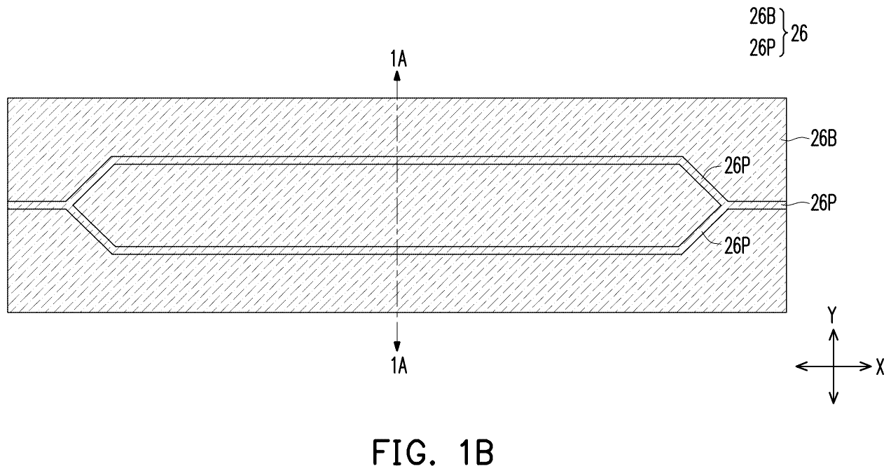

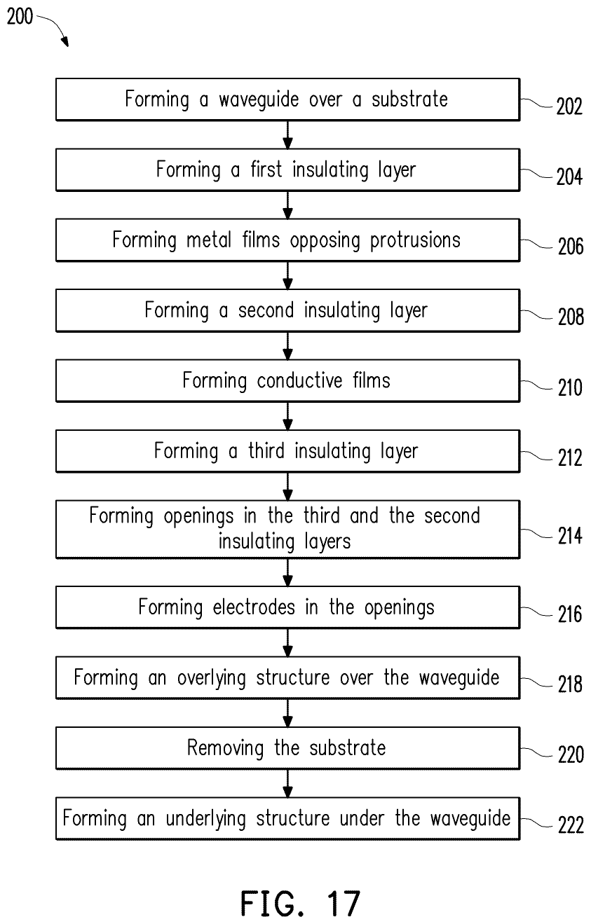

FIGS. 1A and 1B through FIGS. 6A, 6B, and 6C illustrate the cross-sectional views of intermediate stages in the formation of an electro-optic modulator in accordance with some embodiments of the present disclosure. The corresponding processes are also reflected schematically in the process flow 200 as shown in FIG. 17.

Referring to FIG. 1A, wafer 20 is formed. Wafer 20 may include a plurality of identical device dies 20′, which may be formed as photic integrated circuit (PIC) dies. Wafer 20 includes substrate 22, and insulating layer 24 over substrate 22. In accordance with some embodiments, substrate 22 may be formed of or comprise a silicon substrate, a dielectric substrate, or the like. Insulating layer 24 may be formed of a low-refractive-index material such as silicon oxide.

Waveguide 26 is formed over insulating layer 24. The respective process is illustrated as process 202 in the process flow 200 as shown in FIG. 17. In accordance with some embodiments, waveguide 26 comprises a material that has a high refractive index. For example, waveguide 26 may comprise lithium niobite. Waveguide 26 comprises base layer (base portion) 26B, and protrusions 26P protruding higher than base layer 26B. The base layer 26B and protrusions 26P are joined to each other continuously, with no distinguishable interface in between.

In accordance with some embodiments, the formation of waveguide 26 may comprise depositing a blanket layer, for example, a lithium niobite layer, recessing some portions of the blanket layer, so that the protrusions 26P are formed as being over an underlying portion, which underlying portion forms the base layer 26B. An additional etching process may be performed to remove some parts of the underlying portions, so that waveguide 26 is formed and isolated from the surrounding environment.

FIG. 1B illustrates a top view of an example waveguide 26 in accordance with some embodiments. The waveguide 26 has the lengthwise in the X-direction, with the optical signals being conducted in the X-direction also. Protrusions 26P are merged at opposite ends, and split in the locations between the opposite ends. The structure as shown in FIG. 1A may be obtained from the cross-section 1A-1A in FIG. 1B.

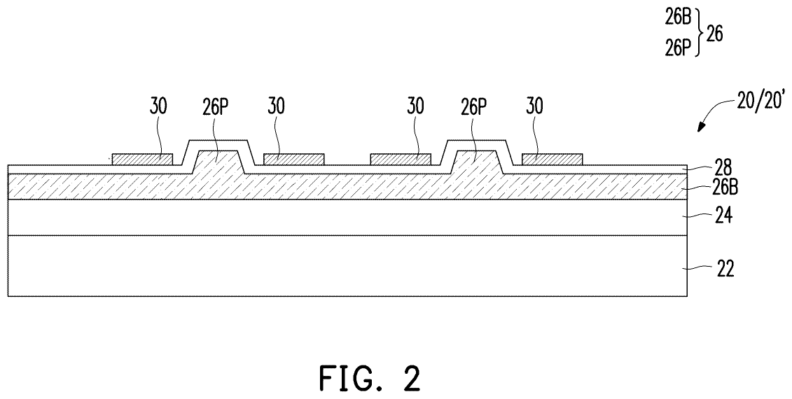

FIG. 2 illustrates the formation of insulating layer 28. The respective process is illustrated as process 204 in the process flow 200 as shown in FIG. 17. In accordance with some embodiments, insulating layer 28 comprises a material that has a refractive index lower than the refractive index of waveguide 26. For example, insulating layer 28 may be formed of ro comprise silicon oxide.

In accordance with some embodiments, the formation of insulating layer 28 includes a blanket deposition process, which may comprise a conformal deposition process such as Atomic Layer Deposition (ALD), Chemical Vapor Deposition (CVD), or the like. The portions of the insulation layer 28 offset from protrusions 26P may have a planar top surface, and the portions of the insulating layer 28 overlapping and adjacent to protrusions 26P may have top surfaces and sidewalls parallel to the respective top surfaces and sidewalls of protrusions 26P.

In accordance with alternative embodiments, the formation of insulating layer 28 includes depositing an insulating material to a level higher than the top surface of protrusions 26P, performing a planarization process such as a Chemical Mechanical Polish (CMP) process or a mechanical polish process to level the top surface of the insulating material, and then etching back the insulating material. In accordance with these embodiments, the protrusions 26P are exposed.

Next, conductive films 30 are formed over insulating layer 28. The respective process is illustrated as process 206 in the process flow 200 as shown in FIG. 17. Conductive films 30 includes portions over, and close to, protrusions 26P. The portions of conductive films 30 on opposite sides of protrusions 26P may be formed as pairs, which pairs are on opposite sides of the corresponding protrusions 26P.

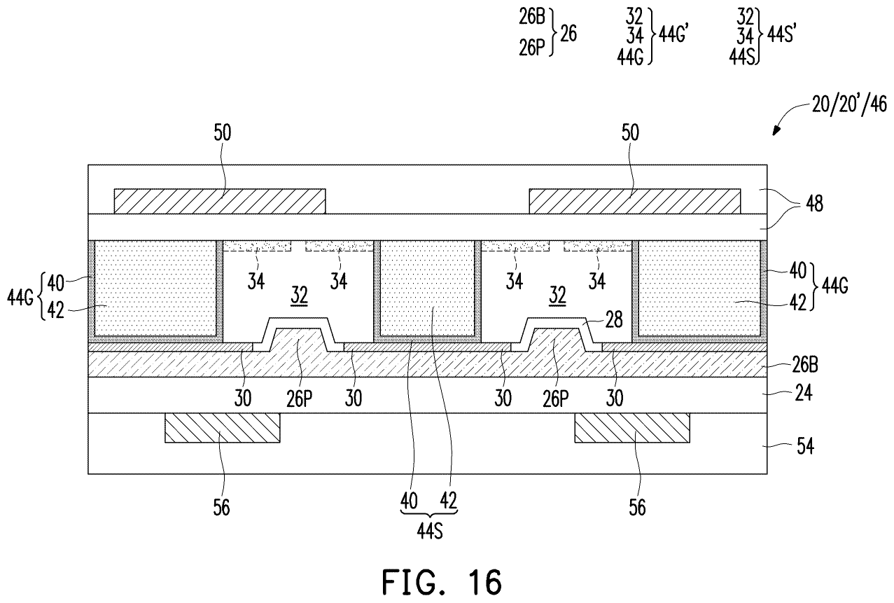

In accordance with some embodiments, conductive films 30 are formed at a level below or level with the top surfaces of protrusions 26P, and higher than or level with the bottom ends of protrusions 26P. Alternatively stated, the bottom surfaces of conductive films 30 may be level with (refer to the embodiment in FIG. 16) the bottom ends of protrusions 26P. The top surfaces of conductive films 30 may be level with or lower than the top surfaces of protrusions 26P.

Conductive films 30 may comprise metal, and hence are alternatively referred to as metal films, while other conductive materials such as doped silicon may also be used. In accordance with some embodiments, the formation of conductive films 30 may include a deposition process such as a Physical Vapor deposition (PVD) process, CVD, a plating process, or the like, followed by a patterning process through etching to define patterns of the conductive films 30. Conductive films 30 may comprise Ta, TaN, Ti, TiN, W, Co, Cu, Indium Tin Oxide (ITO), or the like, alloys thereof, and/or multilayers thereof.

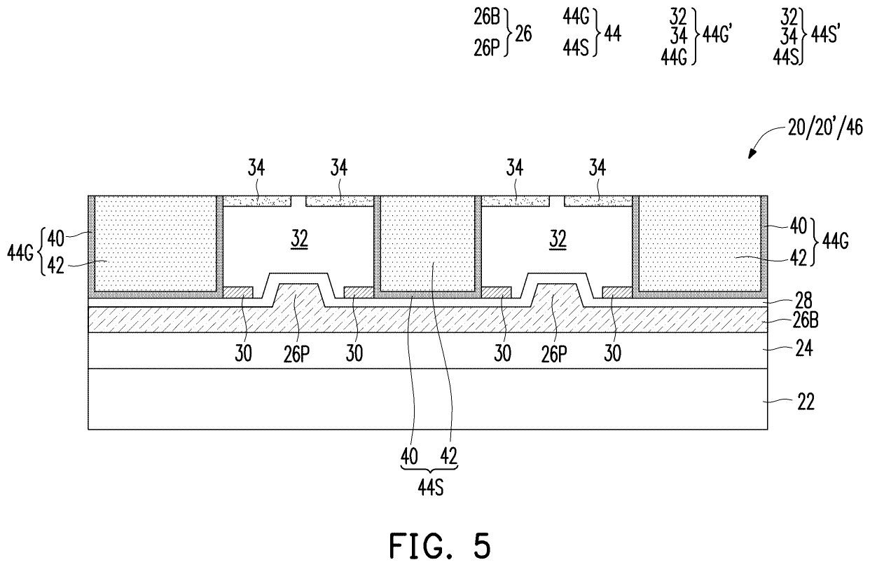

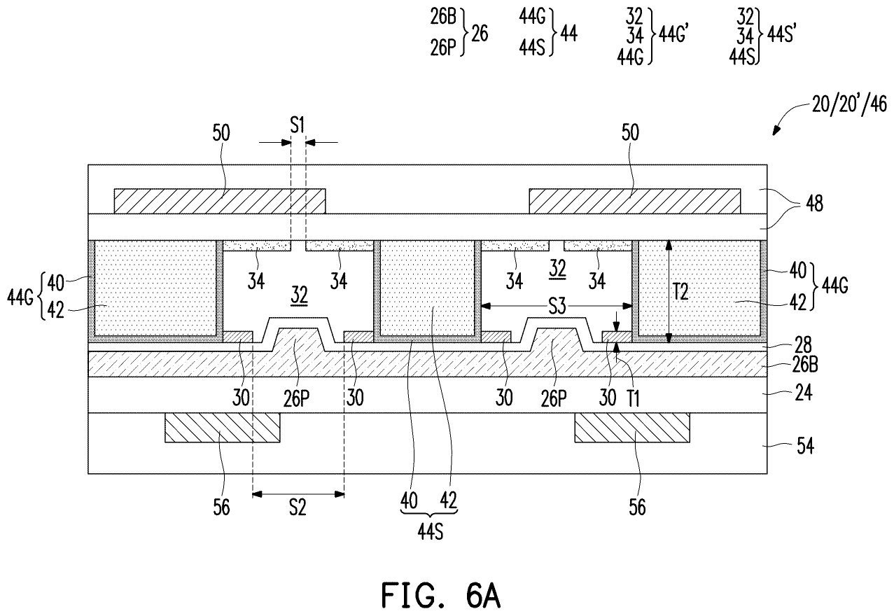

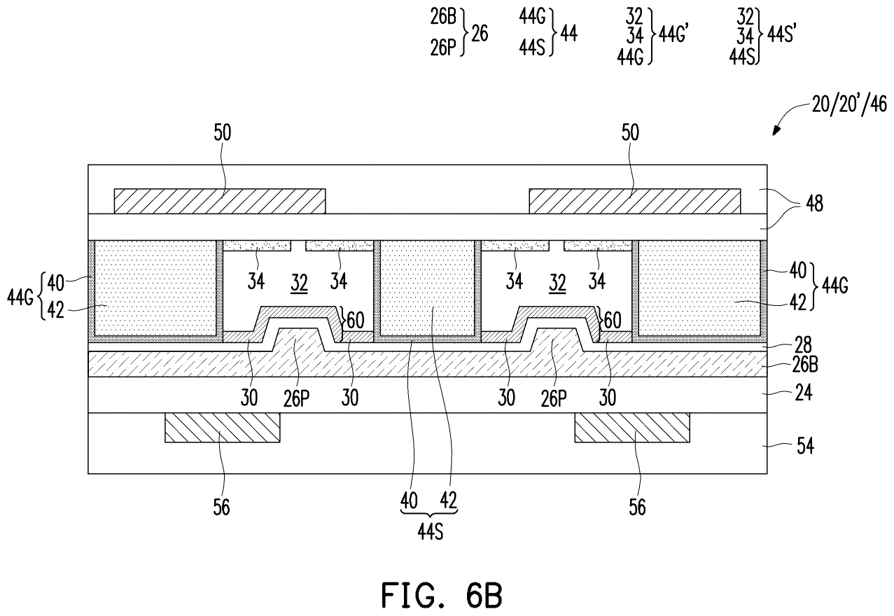

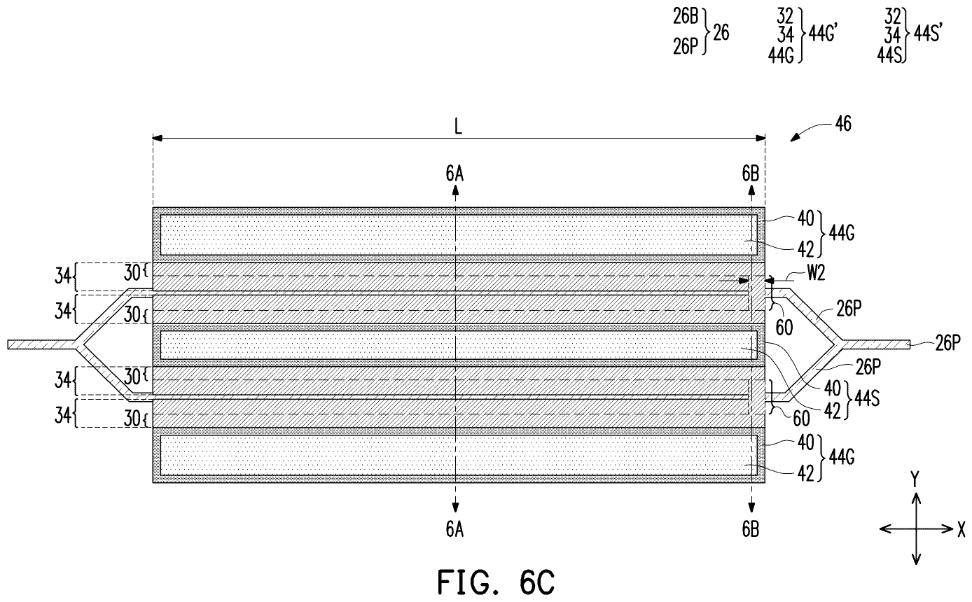

Conductive films 30 may be formed of a homogeneous material as discussed above. Alternatively, conductive films 30 may have a composite structure including a barrier layer and a metal layer over the barrier layer, which composite structure is similar to the structure of electrodes 44 (FIG. 5), except that the height (thickness) of conductive films 30 is smaller than the height (thickness T2 as in FIG. 6A) of electrodes 44.

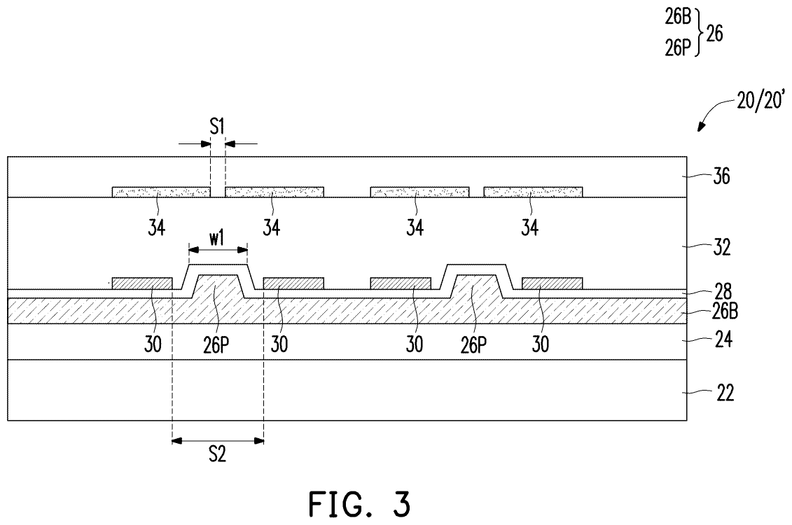

Referring to FIG. 3, insulating layer 32 is formed. The respective process is illustrated as process 208 in the process flow 200 as shown in FIG. 17. The formation of insulating layer 32 may include depositing an insulating material to a level higher than the top surface of protrusions 26, and performing a planarization process such as a CMP process or a mechanical polish process to level the top surface of the insulating material. The insulating material may include silicon oxide or other materials with a low refractive index, for example, lower than the refractive index of waveguide 26.

Next, conductive films 34 are formed over insulating layer 28. The respective process is illustrated as process 210 in the process flow 200 as shown in FIG. 17. Conductive films 34 include some portions overlapping metal films 30, and possibly some portions overlapping protrusions 26P. Some portions of conductive films 34 are also vertically offset from protrusions 26P. The portions of conductive films 34 may be formed as pairs, with each pair overlapping a pair of metal films, and possibly one of protrusions 26P. The middle point of the closely located conductive films 34 may be vertically aligned to (flush with) the centers of the corresponding underlying protrusions 26P.

In accordance with some embodiments, the spacing S1 between the conductive films 34 in the same pair may be smaller than the spacing S2 between the underlying metal films 30. The spacing S1 may also be smaller than, equal to, or greater than, the width W1 of protrusions 26P. Forming conductive films 34 with smaller spacings may improve the effect of confining electrical fields, as discussed referring to FIGS. 6A, 6B, and 6C.

Conductive films 34 may comprise a metal or a metal alloy, and hence are alternatively referred to as metal films, while other conductive materials such as doped silicon may also be used. In accordance with some embodiments, the formation of conductive films 34 may include PVD, CVD, or the like. Conductive films 34 may comprise Ta, TaN, Ti, TiN, W, Co, Cu, Indium Tin Oxide (ITO), or the like, alloys thereof, and/or multilayers thereof. The material of conductive films 34 may be the same as or different from the material of metal films 30.

Conductive films 34 may be formed of a homogeneous material as discussed above. Alternatively, conductive films 34 may have a composite structure including a barrier layer and a metal layer over the barrier layer, which composite structure is similar to the structure of electrodes 44 (FIG. 5), except the height (thickness) of conductive films 34 is smaller than the height (thickness T2 as in FIG. 6A) of electrodes 44.

In accordance with some embodiments, as shown in FIG. 3, both of metal films 30 and 34 are formed. In accordance with alternative embodiments, metal films 30 are formed, while metal films 34 are not formed. In accordance with yet alternative embodiments, metal films 30 are not formed, while metal films 34 are formed.

Further referring to FIG. 3, insulating layer 36 is formed. The respective process is illustrated as process 212 in the process flow 200 as shown in FIG. 17. The formation of insulating layer 36 may include depositing an insulating material to a level higher than the top surface of metal films 34, and performing a planarization process such as a CMP process or a mechanical polish process to level the top surface of the insulating material. The insulating material may include silicon oxide or other materials with a low refractive index. The materials of insulating layers 36, 32, and 28 may be the same as each other or different from each other in any combination. When insulating layers 36, 32, and 28 are formed of the same materials, the interfaces in between may be, or may not be, distinguishable.

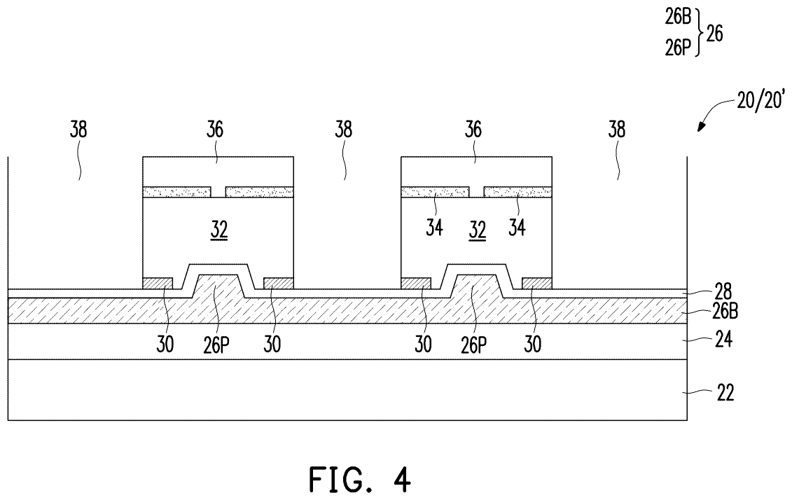

Referring to FIG. 4, a patterning process is performed to form openings 38. The respective process is illustrated as process 214 in the process flow 200 as shown in FIG. 17. In accordance with some embodiments, the patterning process is performed through anisotropic etching process(es), so that insulating layers 36, 32, and 28 are etched. After the patterning process, at least some portions of metal films 30 are exposed, and the edges of conductive films 34 are also exposed to openings 38.

In accordance with some embodiments, insulating layers 36 and 32 are formed of a same material such as silicon oxide. Accordingly, insulating layer 36 and 32 are illustrated as being merged together in subsequent figures, while they may also be formed of different materials. The interfaces between insulating layer 36 and 32 may be, or may not be, distinguishable.

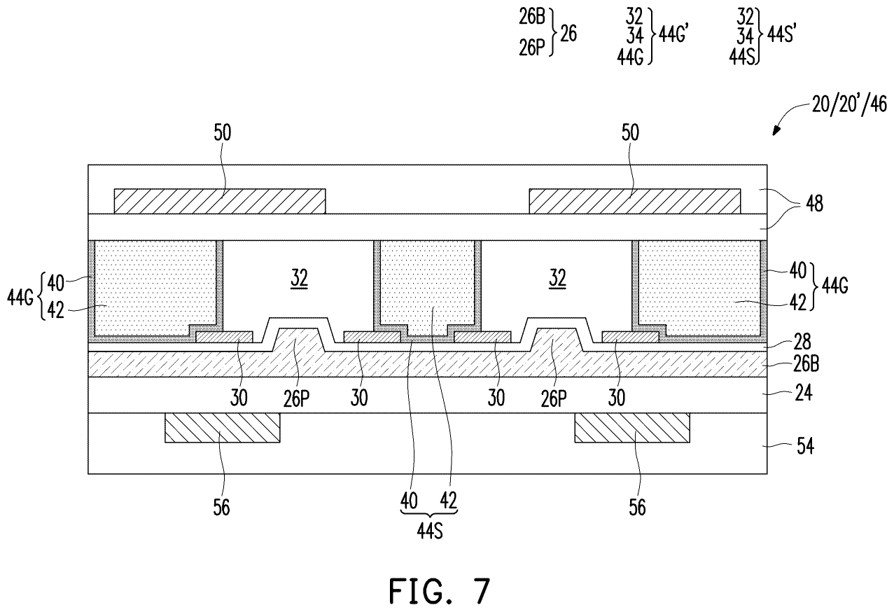

In accordance with some embodiments, the exposed portions of metal films 30 may be the edges of metal films 30. In which embodiments, in the etching process, the metal films 30 are also etched. In accordance with alternative embodiments, the exposed portions of metal films 30 are not etched, and hence both of the top surfaces and the edges of the metal films 30 are exposed. The corresponding structure may be realized from FIG. 7. Furthermore, in the etching process, metal films 34 are etched, so that the edges of metal films 34 are exposed, while the top surfaces of the remaining portions of metal films 34 are covered by insulating layer 36.

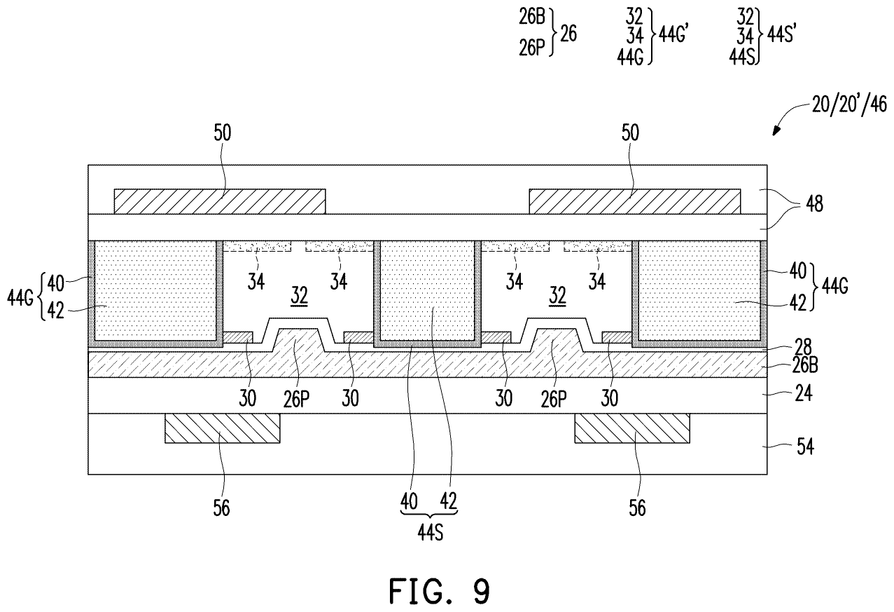

The etching process may be stopped at the top surface of insulating layer 28 (as shown in FIG. 4), or at an intermediate level between the top surface and the bottom surface of insulating layer 28 (as may be realized from FIG. 9). The etching process may also be stopped at the top surface of conductive films 30 using conductive films 30 as an etch stop layer. In these embodiments, at the bottom surfaces of openings 38, insulating layer 28 is exposed, and the top surfaces of conductive films 30 are exposed. The etching process may also be stopped on the top surfaces of waveguide 26, and hence the top surface of the base layer 26P of the waveguide 26 is exposed.

Referring to FIG. 5, electrodes 44S and 44G are formed in openings 38. The respective process is illustrated as process 216 in the process flow 200 as shown in FIG. 17. Electrodes 44G may be used as electrical ground nodes. Electrode 44S is a signal node, on which varying voltages are applied for applying electrical signals. Electrodes 44S and 44G are individually and collectively referred to as electrodes 44 also. It is appreciated that although signal node 44S is between ground nodes 44G, in accordance with alternative embodiments, electrical ground node 44G may be located between signal nodes 44S.

In accordance with some embodiments, electrodes 44 may include conductive liners 40, such as diffusion barrier layers, adhesion layers, or the like. In some embodiments, the formation of electrodes 44 includes performing a blanket deposition process to form conductive liners 40, depositing a thin seed layer of copper or copper alloy, and filling the rest of openings 38 with a metallic material (which forms metal regions 42). The deposition process for forming conductive liners 40 and the seed layer may include PVD, CVD, ALD, or the like. Conductive liners 40 may include titanium, titanium nitride, tantalum, tantalum nitride, or other alternatives.

The filling process for forming metal regions 42 may comprise, for example, electro-plating, electro-less plating, deposition, or the like. A CMP process may be performed to level the surface of conductive liners 40 and the filling material, and to remove excess material from the surface of insulating layer 36.

Electro-optic modulator 46 is thus formed as comprising waveguide 26, conductive films 30 and 34, and electrodes 44S and 44G. Throughout the description, electrode 44S, the metal films 30, and the conductive films 34 that are electrically connected to the electrode 44S are collectively referred to as (composite signal) electrode 44S′. Each of the electrodes 44G and the metal films 30 and the metal films 34 that are electrically connected to the corresponding electrode 44G are collectively referred to as (composite ground) electrode 44G′.

In the operation of electro-optic modulator 46, electrode 44S (and accordingly electrode 44S′) may be used as a signal node, on which electrical signals are applied. The electrical signals are modulated into optical signals by the electro-optic modulator 46. Electrodes 44G (and accordingly electrodes 44G′) may be used as ground nodes, which are electrically grounded and/or may have voltage VSS.

Referring to FIG. 6A, an overlying structure is formed over electro-optic modulator 46 to continue the formation of wafer 20. The respective process is illustrated as process 218 in the process flow 200 as shown in FIG. 17. The overlying structure may include dielectric layers 48, optical devices 50, and electrical connections (not shown) for conducting electrical signals to the signal node 44S′ and ground nodes 44G′.

The dielectric layers 48 may comprise silicon oxide, silicon oxynitride, or the like. The optical devices 50 may include waveguides (such as nitride waveguides or silicon waveguides), grating couplers, edge couplers, or the like. The Electrical connections connecting to the electrode-optic modulator 46 may comprise contact plugs, metal lines, vias, and/or the like, which may be connected to the signal node 44S′ and ground nodes 44G′.

Next, the substrate 22 as shown in FIG. 5 may be removed. The respective process is illustrated as process 220 in the process flow 200 as shown in FIG. 17. The removal process may include attaching a carrier (not shown) to the front side of wafer 20, and performing a polishing process on substrate 20. An implantation process may also be performed to form a layer (which may comprise hydrogen, for example) in substrate 20, followed by an annealing process, so that a bulk portion of the substrate 20 may be detached from a remaining layer of the substrate 20.

A polishing process may then be performed to remove the remaining layer of substrate 20, exposing insulating layer 28. Alternatively, the remaining layer of substrate 20 may be patterned to form optical devices such as silicon waveguides, grating couplers, and/or the like.

As shown in FIG. 6A, an underlying structure is formed underlying electro-optic modulator 46. The respective process is illustrated as process 222 in the process flow 200 as shown in FIG. 17. The underlying structure may include dielectric layers 54, and optical devices 56. The dielectric layers 54 may comprise silicon oxide, silicon oxynitride, or the like. The optical devices 54 may include waveguides (such as nitride waveguides or silicon waveguides), grating couplers, edge couplers, or the like. The optical devices 56 may also represent the optical devices formed using the remaining portions of substrate 20.

After both of the overlying and underlying structure of wafer 20 are formed to finish the formation of wafer 20, wafer 20 may be sawed into individual device dies 20′, which may be PIC dies.

FIG. 6C illustrates a top view of electro-optic modulator 46 in accordance with some embodiments. As shown in FIG. 6C, the signal electrode 44S′ is on an opposite side of each of protrusions 26P than one of ground electrodes 44′G. The signal electrode 44S′ and ground electrodes 44′G thus may apply electrical fields to both of protrusions 26P. When the magnitudes of electrical fields are changed due to the changed electrical signals, the refractive index of protrusions 26P are changed, and hence the optical signals in the protrusions 26P are changed (modulated) to reflect the electrical signal. The electrical signals are thus converted into optical signals by the electro-optic modulator 46.

The magnitude of the modulation of the optical signal is related to the magnitude of the electrical fields. The electrical fields are proportional to the voltage difference between signal electrode 44S′ and ground electrodes 44′G, and are inversely proportional to the spacing between the signal electrode 44S′ and ground electrodes 44′G. Referring to FIG. 6A, the electrical fields are applied by pairs of metal films 30 that are on the opposite sides of protrusions 26P.

If metal films 30 are not formed, the spacing between neighboring electrodes 44G and 44S would be S3 (FIG. 6A). The formation of metal films 30 reduces the spacing from S3 to S2, and hence the electrical fields are increased without the need of applying greater voltages. The efficiency of the modulation is thus improved. In accordance with some embodiments, spacing ratio S2/S3 may be smaller than about 0.8, and may be in the range between about 0.3 and about 0.8.

In addition, metal films 34 have the function of confining electrical fields to be in the respective lower regions, and may function as a reflector for reflecting the energy that may scatter in the upward direction. Accordingly, metal films 34 also have the function of increasing electrical fields applied to waveguide 26, without requiring the increase of voltages.

In accordance with some embodiments, the thickness T1 of metal films 30 is significantly smaller than the thickness T2 (height) of electrodes 44S and 44G. The thickness ratio T1/T2 may be smaller than about 0.1, and may be in the range between about 0.05 and 0.1. Accordingly, while metal films 30 have the function of reducing the spacing between signal and ground electrodes, since metal films 30 are much thinner than electrodes 44S and 44G, metal films 30 have lower interference to optical signals than electrodes 44S and 44G.

FIG. 6A illustrates the cross-section 6A-6A in FIG. 6C. FIG. 6B illustrates the cross-section 6B-6B in FIG. 6C. In the cross-section as shown in FIG. 6B, termination resistors 60 are formed to electrically connect ground electrodes 44G′ to signal electrode 44S′. The termination resistors 60 have the function of adjusting impedance of electro-optic modulator 46. As shown in FIG. 6B, termination resistors 60 may be formed using the same material as, and in the same formation process, as the formation of metal films 30. The resistance of the termination resistors 60 may be adjusted by adjusting the width W2 (FIG. 6C). In accordance with these embodiments, as shown in FIG. 6B, termination resistors 60 are formed at locations higher than metal films 30.

By forming metal films 30, the size of the electro-optic modulator 46 may be reduced without the adverse reduction in the bandwidth of the electro-optic modulator 46. For example, with the formation of metal films 30, the length L (FIG. 6C) of the electro-optic modulator 46 may be reduced to about 60 to about 80 percent of the length of the electro-optic modulator (even if metal films 34 are not formed), while still maintain the bandwidth of the electro-optic modulator 46 not reduced, or even increased.

By forming both of metal films 30 and 34, the size of the electro-optic modulator 46 may be further reduced without the adverse reduction in the bandwidth of the electro-optic modulator 46. For example, with the formation of both of metal films 30 and 34, the length L (FIG. 6C) may be reduced to about 25 percent and about 40 percent of the length of the electro-optic modulator that do not have metal films 30 and 34, while still maintain the bandwidth of the electro-optic modulator 46 not reduced, or even increased.

FIGS. 7 through 16 illustrate the views of electro-optic modulators 46 in accordance with alternative embodiments. Unless specified otherwise, the materials, the structures, and the formation processes of the components in these embodiments are essentially the same as the like components denoted by like reference numerals in the preceding embodiments. The details regarding the materials, the structures, and the formation processes provided in each of the embodiments throughout the description may be applied to any other embodiment whenever applicable.

It is appreciated that the different structures in FIGS. 7 through 16 may be adopted to help to match the optical characteristic of the waveguide 26 to the electrical characteristic of the electrodes 44G′ and 44S′. As a result, the performance of the electro-optic modulators may be tuned as being optimal.

Furthermore, in some of the embodiments as shown in FIGS. 7 through 16, metal films 34 are illustrated as being dashed to indicate that in each of these embodiments, metal films 34 may or may not be formed.

FIG. 7 illustrates the electro-optic modulator 46 in accordance with alternative embodiments. These embodiments are similar to the embodiments as shown in FIGS. 6A, 6B, and 6C, except that metal films 30 are partially underlying and overlapped by electrodes 44. Also, metal films 34 are not formed. In accordance with these embodiments, in the process for forming openings 38 (FIG. 4), instead of etching metal films 30, metal films 30 are used as etch stop layers and are not etched. The top surfaces of the exposed portions of metal films 30 are revealed to openings 38. The remaining processes of forming wafer 20 and PIC die 20′ may be essentially the same as discussed above, and are not repeated herein.

Accordingly, in subsequent formation of electrodes 44, the conductive liners 40 may be formed conformally on the exposed top surfaces and sidewalls of metal films 30. Also, since parts of metal films 30 are exposed, and electrodes 44 are formed on the exposed parts, metal films 30 may also be considered as parts of the seed layer for forming electrodes 44G′ and 40S′.

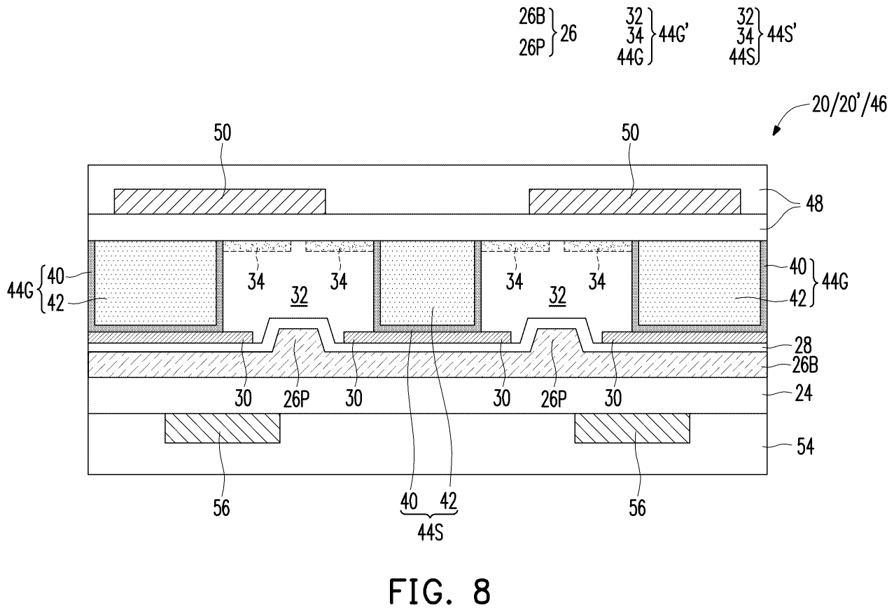

FIG. 8 illustrates the electro-optic modulator 46 in accordance with alternative embodiments. These embodiments are similar to the embodiments as shown in FIGS. 6A, 6B, and 6C, except that metal films 30 are underlying the entireties of electrodes 44. Furthermore, metal films 30 extend laterally beyond the edges of electrodes 44S and 44G in the direction toward the protrusions 26P. In the direction away from the protrusions 26P, metal films 30 may extend beyond the edges of electrodes 44G, which edges of electrodes 44G face away from protrusions 26P. Alternatively, metal films 30 may have edges vertically flush with the edges of the overlying electrodes 44G, which edges of electrodes 44G face away from protrusions 26P.

In accordance with these embodiments, in the process for forming openings 38 (FIG. 4), instead of etching metal films 30, metal films 30 are used as etch stop layers and are not etched. The top surfaces of the exposed portions of metal films 30 are revealed to openings 38. Alternatively stated, openings 38 are limited to the regions directly over metal films 30. The remaining processes of forming wafer 20 and PIC die 20′ may be essentially the same as discussed above, and are not repeated herein.

Accordingly, in subsequent formation of electrodes 44, the conductive liners 40 may be formed conformally on the exposed top surfaces of metal films 30. Also, since electrodes 44 are formed on the exposed parts of metal films 30, metal films 30 may also be considered as the seed layer for forming electrodes 44G′ and 40S′.

In accordance with some embodiments, since the entireties of openings 38 overlap metal films 30, metal films 30 may be used as the seed layer for plating metal regions 42, without the need of forming additional barrier layers and seed layers. For example, when metal regions 42 are formed of or comprise tungsten, cobalt, or the like, conductive liners 40, which may also function as diffusion barriers, may be omitted, and the metal material of metal regions 42 may be plated directly from metal films 30, without the need of forming additional seed layer. The resulting electro-optic modulator 46 may be essentially the same as what is shown in FIG. 8, except that conductive liners 40 are not formed, and the entireties of metal regions 42 may be formed using a homogenous material, which may be a metallic material.

FIG. 9 illustrates the electro-optic modulator 46 in accordance with alternative embodiments. These embodiments are similar to the embodiments as shown in FIGS. 6A, 6B, and 6C, except that metal films 30 are formed at a level higher than the bottoms of electrodes 44. Metal films 30 accordingly joined to the electrodes 44 through edge contacts.

In accordance with these embodiments, in the process for forming openings 38 (FIG. 8), metal films 30 may be etched, or alternative, metal films 30 are not etched, and openings 38 are accurately aligned to the edges of metal films 30. After the etching process to exposing the top surface of insulating layer 28, an over-etching process may be performed, and the resulting openings 38 extend into insulating layer 28.

In accordance with some embodiments, the bottom ends of openings 38 may be at a level between the top surface and the bottom surface of insulating layer 28. In accordance with alternative embodiments, insulating layer 28 may be etched-through, and the tops surface of the base layer 26B of waveguide 26 is exposed. The remaining processes of forming wafer 20 and PIC die 20′ may be essentially the same as discussed above, and are not repeated herein.

Accordingly, in subsequent formation of electrodes 44, electrodes 44 extend to a level lower than the bottom surfaces of metal films 30. Electrodes 44 may be separated from waveguide 26 by the remaining portions of insulating layer 28, or may be in physical contact with the base layer 26B of waveguide 26.

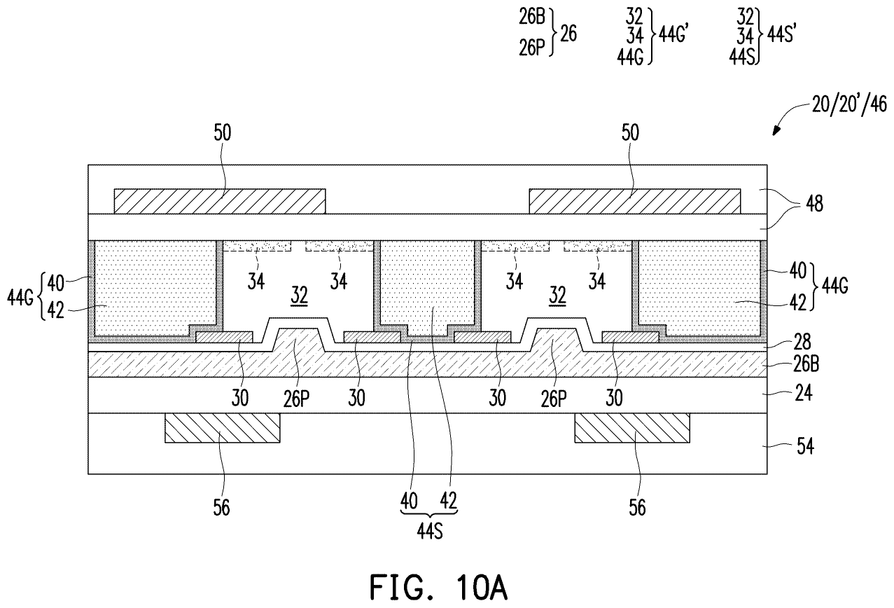

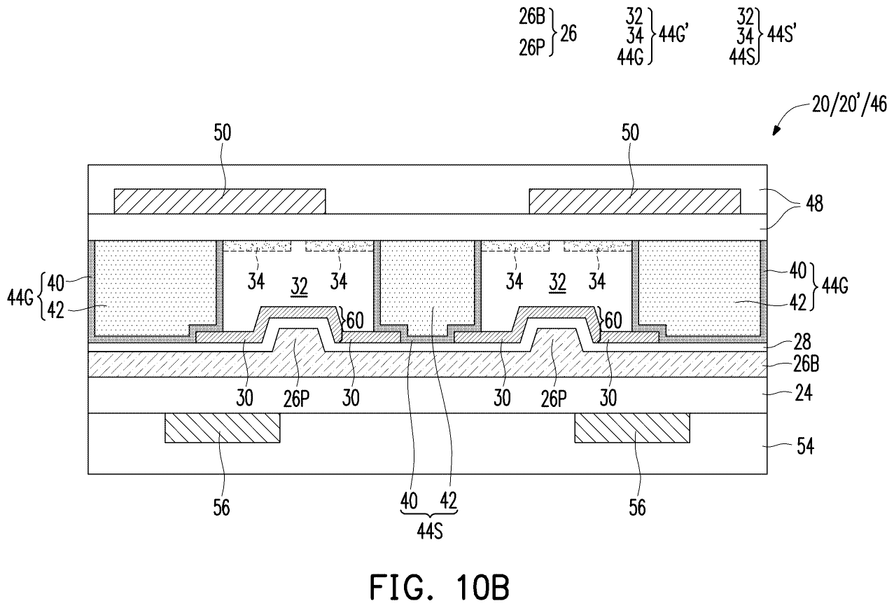

FIGS. 10A, 10B, and 10C illustrate the electro-optic modulator 46 in accordance with alternative embodiments. FIG. 10C illustrates a top view of electro-optic modulator 46 in accordance with these embodiments. FIG. 10A illustrates the cross-section 10A-10A in FIG. 10C, and FIG. 10B illustrates the cross-section 10B-10B in FIG. 10C. These embodiments are similar to the embodiments as shown in FIGS. 6A, 6B, and 6C, except that metal films 30 are partially under electrodes 44, and partially offset (vertically) from electrodes 44. These embodiments may also be essentially the same as the embodiments in FIG. 7. The top view and an additional cross-sectional view are also illustrated.

The structure as shown in FIG. 10A is essentially the same as that in FIG. 7 (except conductive films 34 may be formed in FIG. 10A), and the details are not repeated herein. In the cross-section as shown in FIG. 10B, termination resistors 60 are illustrated. Termination resistors 60 and the portions of the metal film 30 that extend directly underlying electrodes 44 are parts of the continuous metal films, and are formed of the same material and in the same processes.

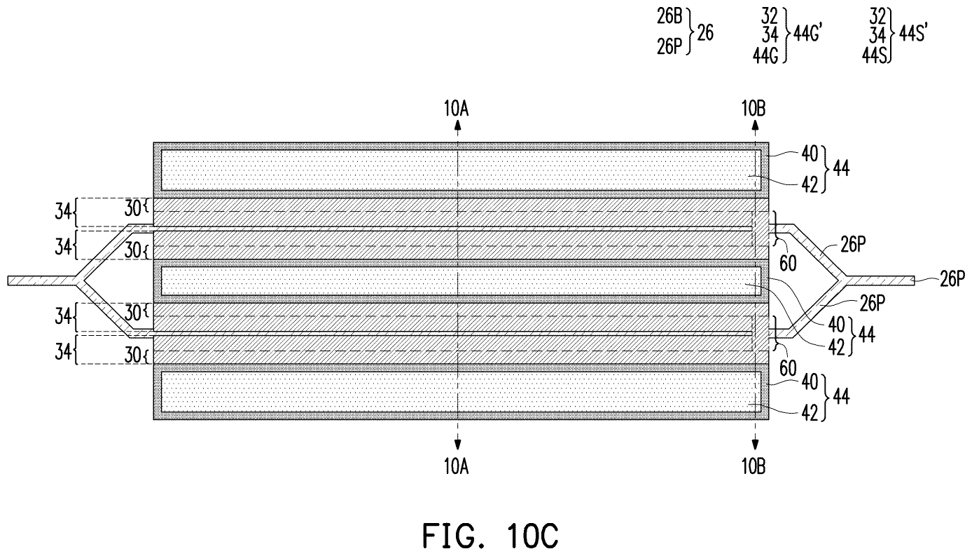

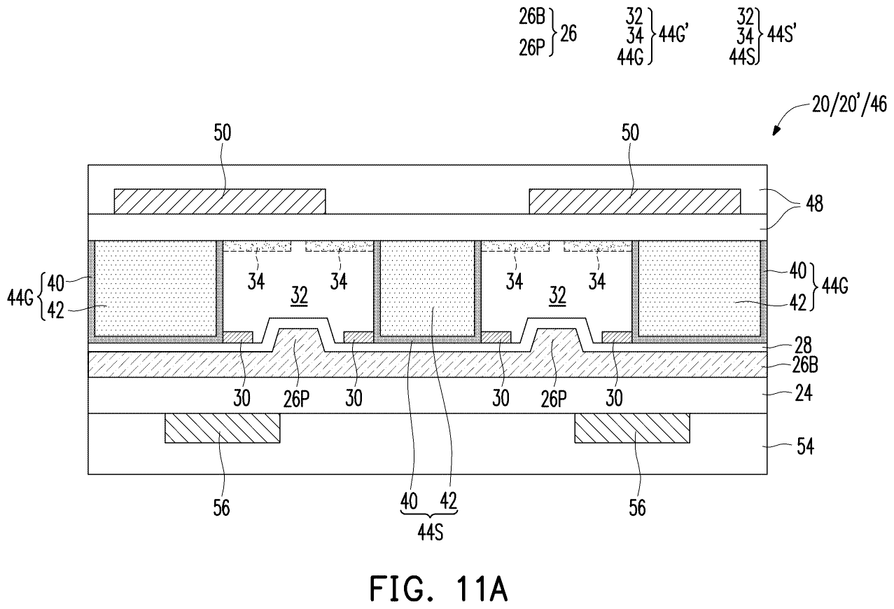

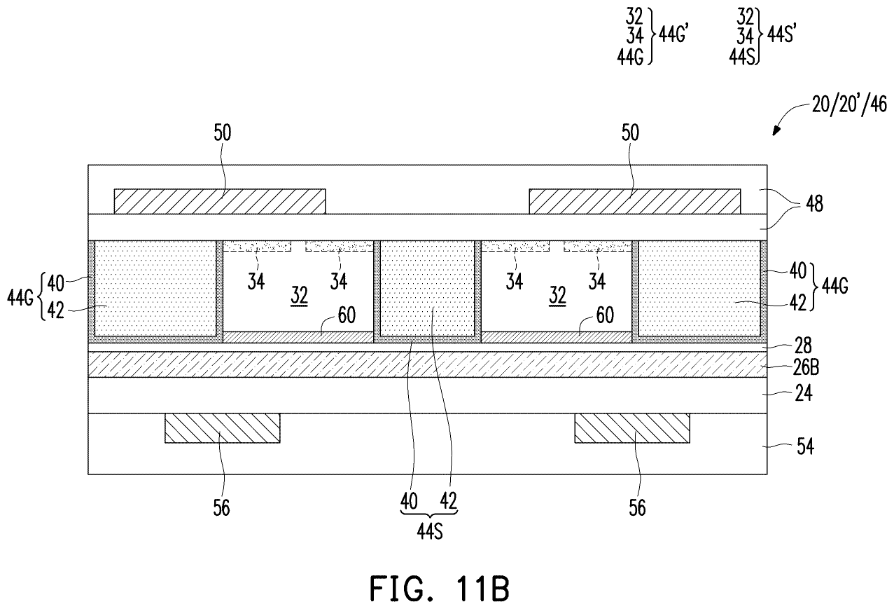

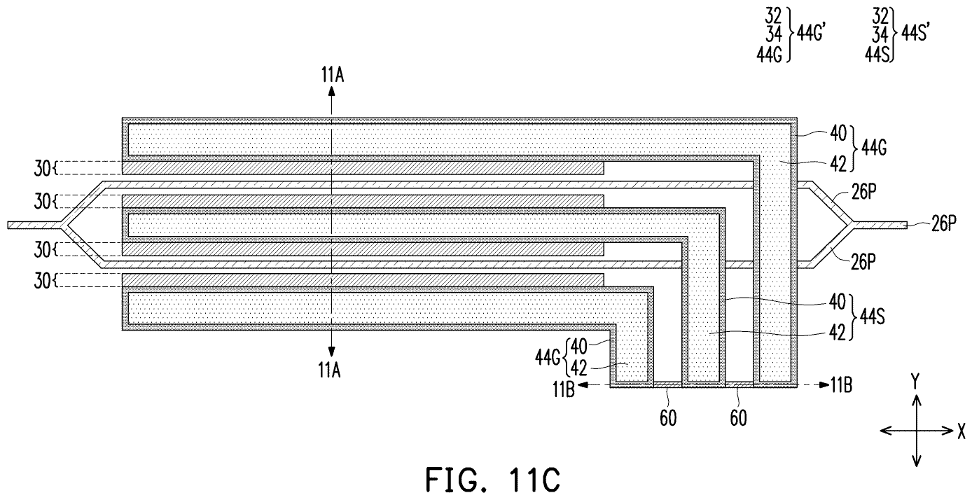

FIGS. 11A, 11B, and 11C illustrate the electro-optic modulator 46 in accordance with alternative embodiments. FIG. 11C illustrates a top view of electro-optic modulator 46 in accordance with these embodiments. FIG. 11A illustrates the cross-section 11A-11A in FIG. 11C, and FIG. 11B illustrates the cross-section 11B-11B in FIG. 11C. These embodiments are similar to the embodiments as shown in FIGS. 6A, 6B, and 6C, except that the end portions of electrodes 44G and 44S have lengthwise directions turned from X-direction to Y direction, and thus are no longer directly over protrusions 26P.

The structure as shown in FIG. 11A is essentially the same as that in FIG. 6A, and the details are not repeated herein. In the cross-section as shown in FIG. 11B, termination resistors 60 is formed. Termination resistors 60 and the portions of the metal film 30 that extend directly underlying electrodes 44 are discrete parts of the same metal film, and are formed as part of the same planar films.

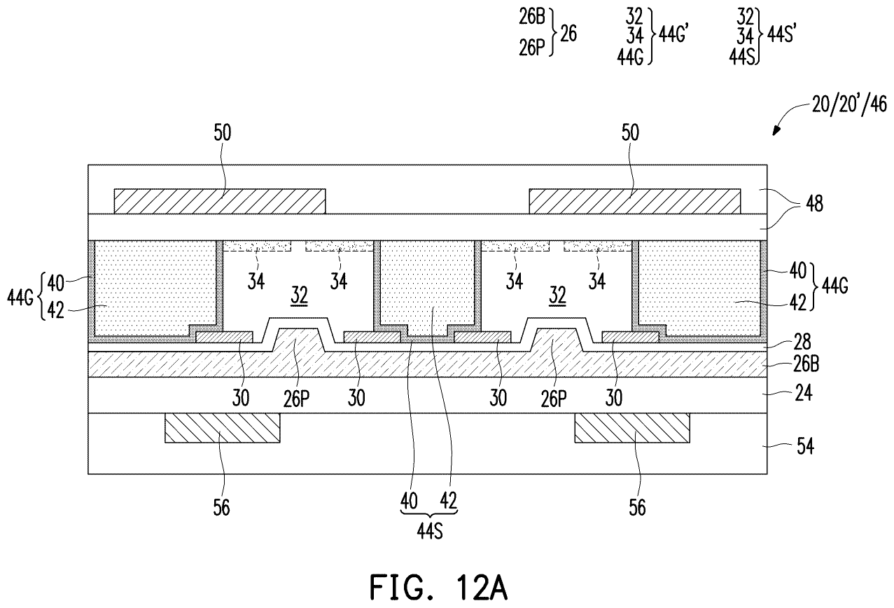

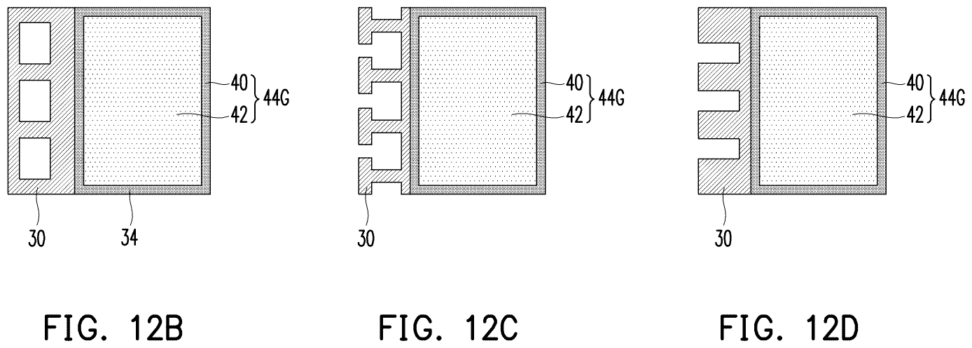

FIGS. 12A, 12B, 12C, and 12D illustrate the electro-optic modulator 46 in accordance with alternative embodiments. FIG. 11A illustrates a cross-sectional view, and FIGS. 12B, 12C, and 12D illustrate top views of the electrodes 44 (and electrodes 44G′ and 44S′) in accordance with various embodiments. These embodiments are similar to the embodiments as shown in FIGS. 6A, 6B, and 6C, except that metal films 30 are further patterned to form openings therein. It is appreciated that FIGS. 12B, 12C, and 12D illustrate some example patterns, and all other applicable patterns are also in the scope of the present disclosure.

The patterning of metal films 30 may help to reduce the pattern loading effect in the formation of metal films 30 (the process as shown in FIG. 3). This structure may help to tune the electrical fields between electrodes 44, and help to match the optical characteristic of electro-optic modulator 46. As a result, the performance of the electro-optic modulator 46 is improved.

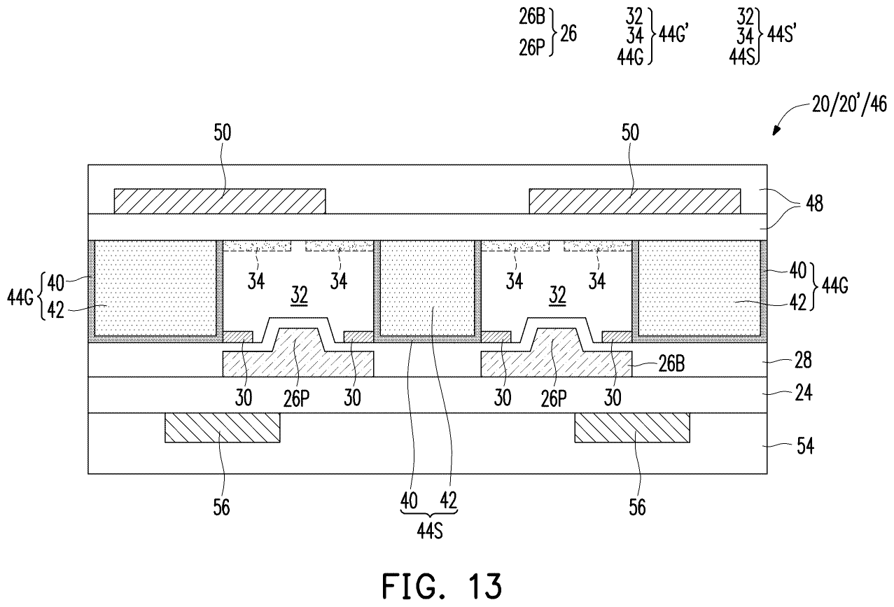

FIG. 13 illustrates the electro-optic modulator 46 in accordance with alternative embodiments. These embodiments are similar to the embodiments as shown in FIGS. 6A, 6B, and 6C, except that the base layer 26B of the waveguide 26, instead of formed as a continuous layer extending from the left edge of the left ground electrode 44G to the right edge of the right ground electrode 44G, may be separated as two discrete portions. Each of the two discrete portions may be directly underlying, and laterally extend beyond the edges of, the corresponding protrusions 26P. This structure may help to match the optical characteristic of the waveguide 26 to the electrical characteristic of the electrodes 44G′ and 44S′. As a result, the performance of the electro-optic modulator 46 is improved.

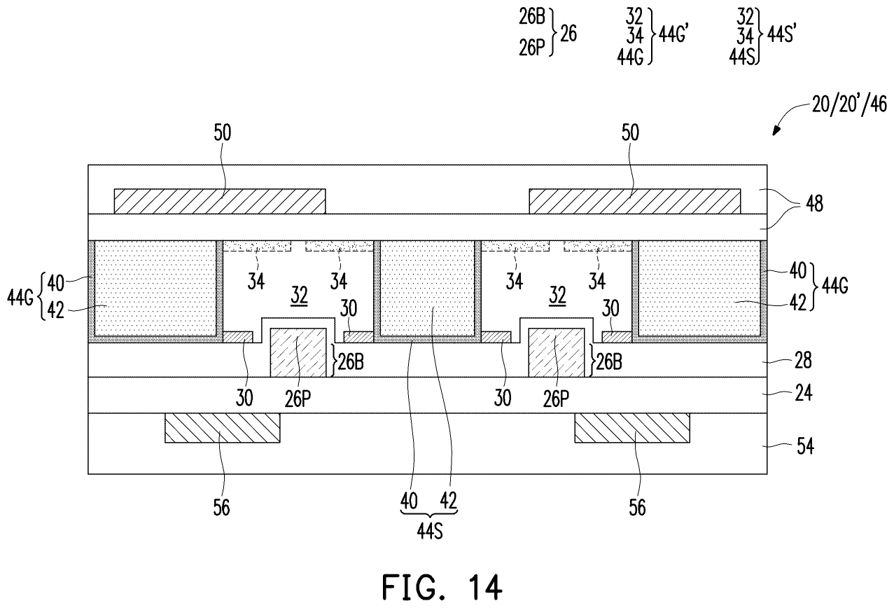

FIG. 14 illustrates the electro-optic modulator 46 in accordance with alternative embodiments. These embodiments are similar to the embodiments as shown in FIGS. 6A, 6B, and 6C, except that the base layer 26B of the waveguide 26 may be separated as two discrete portions. Also, the edges of the protrusions 26P and the base layer 26B may be vertically flushed. This structure may help to match the optical characteristic of the waveguide 26 to the electrical characteristic of the electrodes 44G′ and 44S′. As a result, the performance of the electro-optic modulator 46 is improved.

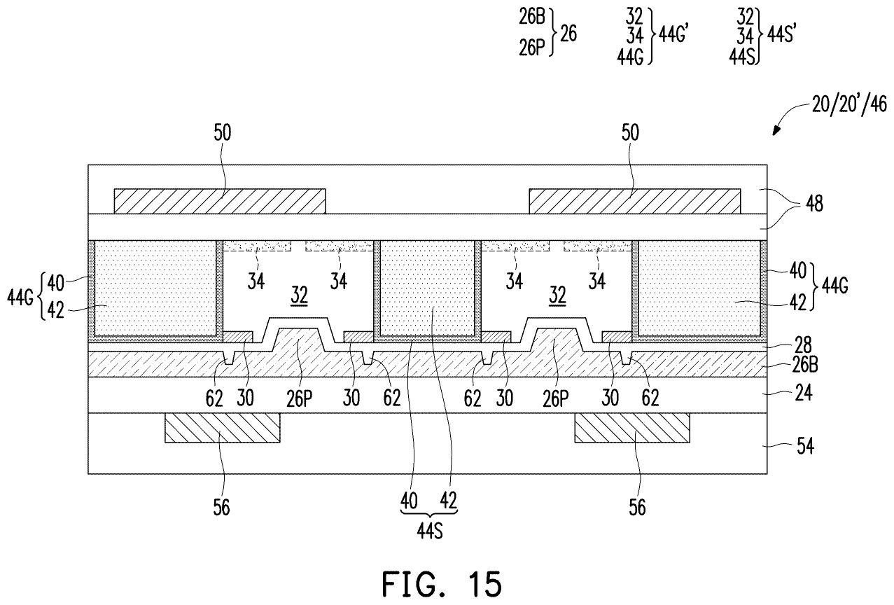

FIG. 15 illustrates the electro-optic modulator 46 in accordance with alternative embodiments. These embodiments are similar to the embodiments as shown in FIGS. 6A, 6B, and 6C, except that notches 62 are formed in waveguide 26, for example, by etching waveguide 26. The notches 62 may be vertically aligned to metal films 30 and/or electrodes 44. The formation of notches 62 may help to match the optical characteristic of the waveguide 26 to the electrical characteristic of the electrodes 44G′ and 44S′. As a result, the performance of the electro-optic modulator 46 is improved.

FIG. 16 illustrates the electro-optic modulator 46 in accordance with alternative embodiments. These embodiments are similar to the embodiments as shown in FIGS. 6A, 6B, and 6C, except that metal films 30 are in physical contact with waveguide 26, in order to simply the manufacture process.

The embodiments of the present disclosure have some advantageous features. By forming metal films to reduce the spacing between signal electrode and ground electrode, the electrical fields applied to the waveguide may be increased. The electro-optic modulation efficiency is improved.

In accordance with some embodiments of the present disclosure, a method comprises forming a waveguide that comprises a base layer and a protrusion over and joined to the base layer; forming first metal film and a second metal film on opposing sides of the protrusion; forming an insulating layer over the first metal film and the second metal film; forming a first electrode aside of the protrusion and electrically coupling to the first metal film, wherein the first electrode is in the insulating layer, and wherein the first metal film comprises a first portion between the first electrode and the protrusion; and forming a second electrode aside of the protrusion and electrically coupling to the second metal film, wherein the second electrode is in the insulating layer, wherein the second metal film comprises a second portion between the second electrode and the protrusion, and wherein the first electrode and the second electrode are configured to apply an electrical field to the protrusion.

In an embodiment, after the insulating layer is etched, a portion of the first metal film directly underlying the first opening is also etched. In an embodiment, the forming the first electrode comprises: depositing a diffusion barrier; depositing a metallic material; and performing a planarization process to remove portions of the diffusion barrier and the metallic material over the insulating layer.

In an embodiment, the method further comprises forming a first conductive film and a second conductive film overlapping the first metal film and the second metal film, respectively, wherein after the first electrode and the second electrode are formed, the first electrode and the second electrode are electrically connected to the first conductive film and the second conductive film, respectively.

In an embodiment, the first metal film is spaced apart from the second metal film by a first lateral distance, and the first conductive film is spaced apart from the second conductive film by a second lateral distance smaller than the first lateral distance. In an embodiment, the first metal film overlaps a first part of the protrusion, and the second metal film overlaps a second part of the protrusion. In an embodiment, the waveguide is formed over a substrate, and the method further comprises: removing the substrate; and forming an optical device on an opposing side of the waveguide than the insulating layer.

In an embodiment, the method further comprises forming a termination resistor, wherein the termination resistor is formed sharing common processes as the first metal film and the second metal film. In an embodiment, the termination resistor is formed directly over, and crossing over, the protrusion. In an embodiment, the termination resistor is formed as a planar resistor at a same plane as the first metal film and the second metal film. In an embodiment, the first portion of the first metal film is patterned.

In accordance with some embodiments of the present disclosure, a method comprises forming a waveguide that comprises a base layer and a protrusion over the base layer; forming a first metal film and a second metal film higher than the base layer and lower than a top end of the protrusion, wherein the first metal film is on an opposing side of the protrusion than the second metal film, and is spaced apart from the second metal film by a first spacing; and forming a ground electrode and a signal electrode connecting to the first metal film and the second metal film, respectively, wherein the ground electrode is spaced apart from the signal electrode by a second spacing greater than the first spacing, and wherein the first metal film, the second metal film, the ground electrode, the signal electrode, and the waveguide collectively form an electro-optic modulator.

In an embodiment, the first metal film and the second metal film are formed in a first formation process, and the ground electrode and the signal electrode are formed in a second formation process separate from the first formation process. In an embodiment, the first metal film and the second metal film have heights smaller than the ground electrode and the signal electrode.

In an embodiment, the method further comprises forming a first conductive film and a second conductive film over the first metal film and the second metal film, wherein the first conductive film and the second conductive film are electrically connected to the ground electrode and the signal electrode, respectively. In an embodiment, the first metal film physically contacts a top surface of the base layer of the waveguide.

In accordance with some embodiments of the present disclosure, a structure comprises an insulating layer; a waveguide over the insulating layer, wherein the waveguide comprises a baser layer and a protrusion over and joined to the base layer; a first electrode and a second electrode on opposing sides of the protrusion; a first metal film electrically connected to the first electrode, wherein a first portion of the first metal film is laterally between the first electrode and the protrusion; and a second metal film electrically connected to the second electrode, wherein a second portion of the second metal film is laterally between the second electrode and the protrusion. In an embodiment, the first electrode is electrically grounded, and the second electrode is connected to a signal node. In an embodiment, the first metal film has a smaller height than the first electrode.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
forming a waveguide that comprises a base layer and a protrusion over and joined to the base layer;
forming first metal film and a second metal film on opposing sides of the protrusion;
depositing an insulating layer over the first metal film and the second metal film;
etching the insulating layer to form a first opening and a second opening in the insulating layer, wherein the first opening and the second opening are on opposing sides of the protrusion, and wherein the first metal film and the second metal film are exposed to the first opening and the second opening, respectively;
forming a first electrode in the first opening, wherein the first metal film comprises a first portion between the first electrode and the protrusion; and
forming a second electrode in the second opening, wherein the second metal film comprises a second portion between the second electrode and the protrusion, and wherein the first electrode and the second electrode are configured to apply an electrical field to the protrusion.

2. The method of claim 1, wherein the first metal film and the second metal film are exposed to the first opening and the second opening, respectively, and the method further comprises filling the first opening and the second opening with a conductive material to form the first electrode and the second electrode.

3. The method of claim 2, wherein after the insulating layer is etched, a portion of the first metal film directly underlying the first opening is also etched.

4. The method of claim 1, wherein the forming the first electrode comprises:
depositing a diffusion barrier;
depositing a metallic material; and
performing a planarization process to remove portions of the diffusion barrier and the metallic material over the insulating layer.

5. The method of claim 1 further comprising:
forming a first conductive film and a second conductive film overlapping the first metal film and the second metal film, respectively, wherein after the first electrode and the second electrode are formed, the first electrode and the second electrode are electrically connected to the first conductive film and the second conductive film, respectively.

6. The method of claim 5, wherein the first metal film is spaced apart from the second metal film by a first lateral distance, and the first conductive film is spaced apart from the second conductive film by a second lateral distance smaller than the first lateral distance.

7. The method of claim 5, wherein the first metal film overlaps a first part of the protrusion, and the second metal film overlaps a second part of the protrusion.

8. The method of claim 1, wherein the waveguide is formed over a substrate, and the method further comprises:
removing the substrate; and
forming an optical device on an opposing side of the waveguide than the insulating layer.

9. The method of claim 1 further comprising forming a termination resistor, wherein the termination resistor is formed sharing common processes as the first metal film and the second metal film.

10. The method of claim 9, wherein the termination resistor is formed directly over, and crossing over, the protrusion.

11. The method of claim 9, wherein the termination resistor is formed as a planar resistor at a same plane as the first metal film and the second metal film.

12. The method of claim 1, wherein the first portion of the first metal film is patterned.

13. A method comprising:
forming a waveguide that comprises a base layer and a protrusion over the base layer;
depositing an insulating layer on the waveguide;
performing a deposition process and a patterning process to form a first metal film and a second metal film, wherein the first metal film and the second metal film are higher than the base layer and lower than a top end of the protrusion, and wherein the first metal film is on an opposing side of the protrusion than the second metal film, and is spaced apart from the second metal film by a first spacing;
depositing an additional insulating layer over the first metal film and the second metal film; and
forming a ground electrode and a signal electrode in the additional insulating layer and connecting to the first metal film and the second metal film, respectively, wherein the ground electrode is spaced apart from the signal electrode by a second spacing greater than the first spacing, and wherein the first metal film, the second metal film, the ground electrode, the signal electrode, and the waveguide collectively form an electro-optic modulator.

14. The method of claim 13, wherein the first metal film and the second metal film are formed in a first formation process, and the ground electrode and the signal electrode are formed in a second formation process separate from the first formation process.

15. The method of claim 13, wherein the first metal film and the second metal film have heights smaller than the ground electrode and the signal electrode.

16. The method of claim 13 further comprising:
forming a first conductive film and a second conductive film over the first metal film and the second metal film, wherein the first conductive film and the second conductive film are electrically connected to the ground electrode and the signal electrode, respectively.

17. The method of claim 16, wherein the first metal film physically contacts a top surface of the base layer of the waveguide.

18. A structure comprising:
an insulating layer;
a waveguide over the insulating layer, wherein the waveguide comprises a baser layer and a protrusion over and joined to the base layer;
a first electrode and a second electrode on opposing sides of the protrusion;
a first metal film electrically connected to the first electrode; and
a second metal film electrically connected to the second electrode.

19. The structure of claim 18, wherein the first electrode is electrically grounded, and the second electrode is connected to a signal node.

20. The structure of claim 18, wherein the first metal film comprises a first portion laterally between the first electrode and the protrusion, and the second metal film comprises a second portion laterally between the second electrode and the protrusion.
